(19) United States
(12) Patent Application Publication
(10) Pub. No.: US 2013/0030685 A1
(43) Pub. Date: Jan. 31, 2013

(54) METHOD FOR DETECTING AND EVALUATING A PLANE

(71) Applicant: Hans-Heinrich Goetting, Lehrte/Roeddensen (DE)

(72) Inventor: Hans-Heinrich Goetting, Lehrte/Roeddensen (DE)

(73) Assignee: Goetting KG, Lehrte/Roeddensen (DE)

(21) Appl. No.: 13/561,149

(22) Filed: Jul. 30, 2012

(30) Foreign Application Priority Data
Jul. 30, 2011 (DE) 10 2011 109 051.0
Oct. 27, 2011 (DE) 10 2011 054 852.1

(51) Int. Cl. B60W 30/08

(52) U.S. Cl. 701/301

(57) ABSTRACT

A method for detecting and evaluating a plane for recognition of an object includes detecting the object using a sensor disposed on a vehicle, the object being present in a direction of a relative direction of movement of the vehicle and the sensor being directed onto the plane. A distance of the sensor from at least one measuring point is determined using a control unit. A value of the determined distance is compared with a reference value so as to obtain a difference value. The difference value is delivered to an evaluation unit as at least one of an object, an obstacle, a hole, a floating particle, a defect in the plane and a measurement error.

### CROSS REFERENCE TO PRIOR APPLICATIONS

Priority is claimed to German Patent Application Nos. DE 10 2011 109 051.0, filed on Jul. 30, 2011 and DE 10 2011 054 852.1, filed on Oct. 27, 2011. The entire disclosure of both applications is incorporated by reference herein.

### FIELD

The invention relates to a method for detecting and evaluating a plane.

### BACKGROUND

Sensors can be used for detecting objects or to recognising obstacles in a danger area. The detection of objects can also be used to determine the position of vehicles. Ultrasound as well as radar methods, inter alia, are suitable for this purpose. However, greater interest has been paid to lasers, in particular laser scanners. It is usual for the laser to emit the laser beam vertically from a rotating, vertical axis. The distance is measured via the reflection at the objects struck by the laser beam. The operativeness of the laser scanner is frequently checked by measurements on a reference surface which is usually located in the rearward part of the device.

A disadvantage of this method is that bodies with a very low remission, i.e. in particular black bodies or holes, are not detected reliably or are not detected at all. Depressions or holes in the carriageway are also not detected.

Laser scanners are usually attached to a relatively low point of the vehicle, partly at a height of 10 or 20 cm above the plane, i.e. the carriageway. If the vehicle then pitches, for example when braking, or if the carriageway rises, the carriageway can mistakenly be recognised as a disruptive obstacle.

Laser scanners are also used in stationary installations, for example in access control. The movement of an object, a vehicle or a person into this area will immediately be recorded as a disturbance or as an alarm.

A disadvantage of these methods is that particularly when used in front of vehicles, they do not reliably detect objects, especially black objects or holes.

### SUMMARY OF THE INVENTION

In an embodiment, a method for detecting and evaluating a plane for recognition of an object is provided. The object is detected using a sensor disposed on a vehicle, the object being present in a direction of a relative direction of movement of the vehicle and the sensor being directed onto the plane. A distance of the sensor from at least one measuring point is determined using a control unit. A value of the determined distance is compared with a reference value so as to obtain a difference value. The difference value is delivered to an evaluation unit as at least one of an object, an obstacle, a hole, a floating particle, a defect in the plane and a measurement error.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows detection of the plane in front of a vehicle;

FIG. 2 shows measurement results;

FIG. 3 shows evaluation results;

FIG. 4 shows detection of the plane in front of a moving vehicle;

FIG. 5 is a plan view of the vehicle shown in FIGS. 1 and 4; and

FIG. 6 is a further plan view of the vehicle.

### DETAILED DESCRIPTION

In an embodiment, the plane to be detected can be compared with reference values; in other words: data exists for a target plane, which data can be compared with the established plane, i.e. with the actual plane. If the differences are excessive or if it is impossible to record any values, the cause can be an object, whereby according to an embodiment of the invention, the term “object” is to be understood as meaning any type and form of obstacle, persons, animals as well as defects in the quality of the plane, in particular of the carriageway, for example recesses or projections.

In an embodiment, a method is provided for detecting planes and in particular for establishing whether objects or obstacles are present in or on the plane or whether defects are present in the plane.

A conformity between the target values and the actual values indicates that there is no discrepancy. The operation of the devices or method can thereby also be tested, particularly if, for example, the target values change during the travel of a vehicle and the actual values follow accordingly. Higher safety levels can be achieved in the evaluation by means of regular operational tests.

The general plane is in principle unlimited, spread-out flat and two-dimensional. However, the detection procedure is restricted to a limited portion. Thus in practice, the plane is delimited at least by the detection range of the sensor technology or by other adjacent planes.

A plane, as well as the reference plane, can be described by three points in the plane. During examination of the plane, it can initially also be checked whether two determined values, i.e. distance values from the measuring sensor to the plane, are located in this plane. A straight line or a line located in the plane can be described using two values. The quality of the examination increases when many values on this straight line correspond to the reference values. The difference of adjacently measured values on the straight lines can be an indication of roughness or unevenness as long as the difference cannot be attributed to a measurement error.

The quality of the plane further increases if the evenness is two-dimensional. The invention is to test whether the plane is as even as possible. In the following, the term “carriageway plane” will also be used instead of the general term “plane”, because the significance of the invention will be seen more often in the object and obstacle detection in front of vehicles.

The plane is the surface which is relevant to the observation. The real plane is more or less smooth and flat. However, it can also have regions with differing gradients or also jumps. The deviations from an ideal plane can be tolerable to a certain extent, depending on the use. Relatively great deviations, for example jumps, can even be used as a marker if they are known.

In an embodiment, for stationary uses, the plane is unchangeable, whereas in mobile uses, the plane changes from the viewpoint of the travelling vehicle. When used with vehicles, it is generally necessary to detect obstacles on the plane mainly in the width of the vehicle and in the length of the stopping distance in front of the vehicle.

In an embodiment, comparatively large objects, i.e. obstacles as well can be reliably detected in a relatively simple manner using the distance measurement to the plane. It becomes more difficult when the objects on the plane are relatively flat and/or small. In this respect it is necessary to distinguish the object from unevennesses of the carriageway or from regions where the carriageway slightly ascends or descends. It is possible in principle to drive over regions of this type.

If the vehicle pitches as a result of accelerating or decelerating, the plane will present itself as being closer or further away. However, this can be tolerated by presetting a specific tolerance for the absolute distance of the plane. For example, the normal expected distance can be 4 m. A distance of the carriageway of apparently 3.80 m or 4.2 m, due to pitching, rolling, ascent or descent, can be quite acceptable. The plane at least still appears to be flat if the entire carriageway plane is flat or if at least a straight line transversely over the carriageway can still be perceived as a straight line.

It is advantageous if a relatively small object, for example an outstretched hand of a person lying on the plane, is reliably recognised. Although a good absolute accuracy is possibly not provided with successive measurements, for example in the case of a laser scan, a relatively accurate, repetitive accuracy is usually provided. Thus it is possible to establish on the plane or when checking the straight lines that here a jump of, for example approximately one centimetre is revealed. In particular, when to the left and right of the hand a plurality of measurements satisfy the requirements imposed on the straight line, but then through the hand a plurality of adjacent measurements do not satisfy this straight line equation, it is possible to conclude that an object or an obstacle is present. A statistically verifiable measuring reliability is produced with a corresponding measuring count. Split beam methods are also suitable for this instead of laser measuring methods.

It is also advantageous that during the transition from the carriageway plane to the hand and from the hand to the carriageway plane in each case a relatively clear jump is produced. This supports the evaluation.

However, it is also possible to detect indentations or bumps in the carriageway, i.e. objects, also obstacles or defects which have a relatively flat ascent relative to the carriageway or to the plane. Here the edges cannot be detected, but nevertheless the statistics also help here to detect these objects in that a plurality of adjacent measurements consolidates the indication of this object. The term “object” is also used to some extent in place of obstacle or defect in the plane.

Furthermore, in an embodiment, the carriageway can be checked on the one hand by comparing the measured values (actual values) with the reference values (target values). This is particularly appropriate for detecting approximate differences. On the other hand, the additional checking of relative differences compared to the ideal plane is provided. This also serves to detect small differences. When both methods, i.e. assessment of the plane by an absolute distance measurement and assessment of the evenness, establish an object in the same location, it is also possible to mutually check both methods. Both methods must indicate the object particularly at reference objects or test objects.

Objects are frequently revealed not only in a three-dimensional manner or in roughness (texture), but also by a visual contrast, for example by a different brightness or colour. For this reason it makes sense to combine a laser scanner method with a camera. Likewise, the reflection of the laser beam can be used for the distance measurement and also to establish different reflectivities of different surfaces (different brightness). A small object which cannot easily be represented by the distance measurement is thus represented more clearly by a different brightness or even by a jump in brightness. If the distance measurement, for example to a hand on the thoroughfare shows only a small difference compared to the distance measurement to the thoroughfare, the reliability in detection improves significantly by the correlating measurement of the differences in brightness between thoroughfare and hand.

It is advantageous to be able to record the entire relevant plane with a photograph or detection. It is then possible to clearly detect steps or jumps in any direction in a relatively simple manner. However, some sensors of this type are complex, slow or inaccurate so that laser scanners which scan the surroundings with a scan line are preferred in principle.

Furthermore, it is advantageous to detect the plane with two lines. In this respect it is possible to use laser scanners or, in order to increase the evaluation speed, to be restricted to merely the evaluation of specific lines or rows in one complete image recording. In this respect, the scan planes or lines are rotated relative to one another such that they intersect or cross one another. One scan could work transversely, while the other is oriented longitudinally or they are both tilted more or less to the left or to the right. The production lines then intersect one another more or less on the carriageway. Objects or oblong obstacles, for example a bar or a step which, in the most unfavourable case, are located transversely on the carriageway could not be reliably detected by only one transversely operating laser scanner. If a further laser scanner is oriented longitudinally, it would detect the bar or step as a jump. However, it is also possible for two laser scanners to be arranged such that one is tilted slightly to the right and the other is tilted slightly to the left. In this case, together they can also detect oblong objects lying on the ground.

In practice, errors occur time and time again when the measurement results are recorded. This can be caused by more or less sporadic faults or by noise in the measuring device or by floating particles (snow, rain, dust) which adversely affect the evaluation.

If unfiltered, these results can simulate an obstacle so that incorrect reactions are then initiated. Therefore, it is advantageous to filter out disruptive measured values. This can be carried out, for example in that deviations from the plane are only recognised as being valid when they are confirmed by a plurality of connected or adjacent measured values. These measured values can be produced in a single measurement recording or by adjacent or temporally successive measurement recordings. If only a single measured value is no longer within the tolerance range, this is not classified as an object, obstacle or defect detection. Only when a specific number, for example more than 5 adjacent measured values or measured values which are also confirmed temporally in the next recording and can be associated with this position, confirms these differences by exceeding the tolerance value, can this object, obstacle or defect be confirmed statistically or by size. A single snowflake would only produce two or three disturbances in this location, whereas a relevant object or obstacle is confirmed only by a greater number of connected measured values.

In an embodiment, other filter methods assist in eliminating disturbances. In this respect, the absolute difference can be considered. The amplitude, i.e. the signal strength of the measured value, can also be assessed. Strong signals are assessed as being higher than weak signals which are possibly close to the noise.

In this respect, distance-measuring laser scanners are particularly advantageous which are fitted to the front of the vehicle in the direction of travel and are directed from above from a suitable height onto the carriageway in a more or less oblique or steeply sloping manner. If they examine at least the stopping distance in front of the vehicle, for example, when danger is detected, the vehicle can be stopped in good time.

Instead of laser scanners, other optical runtime-measuring methods can also be used, also ultrasound and radar with certain restrictions and, depending on the nature of the carriageway, also cameras and stereo cameras with corresponding image processing. When using camera systems, adequate contrast on the carriageway must generally be ensured. Optical methods have better resolutions than ultrasound and radar, but they suffer from problems in poor visibility conditions.

The advantage of sensors which are directed onto the plane from a suitable position compared to conventional laser scanners which are oriented horizontally above the plane is that the plane is examined directly. The plane must be present at the expected distance. A great advantage is that the method is thus reliable in principle. While the laser scanner which is usually oriented horizontally cannot detect black objects or outgoing steps and holes as obstacles, these faults or obstacles are recognised in any case by the new method as deviations from the ideal carriageway.

In an embodiment, when a reflective object appears, it is indicated by a shorter distance than the measurement to the plane. Although reflective objects are also detected by the previous horizontally radiating laser scanners, it is a disadvantage that these laser scanners do not detect objects with a remission which is too low, i.e. black objects. In the case of an optical sensor, for example a laser scanner which directly examines the plane, although a black body would not be seen directly, the absence of measured values can be recognised as an error and thus ultimately also as a danger, so that a warning or stop signal can be generated accordingly.

Depressions in the carriageway, steps, holes and the like in the carriageway plane are also now recognised as obstacles. The depressions etc. can be virtually treated like negative objects.

Features on or in the plane, particularly if they are expected, can also be used as landmarks for navigation purposes.

In addition to the direct detection of objects, a further advantage is provided by the operational test by means of the location-specific reference values to be expected for the plane. Positive conformity means that an operational test has been passed.

The distances between the sensor and the carriageway plane naturally depend on the installation site of the sensor and on the alignment. It makes sense to align the sensor, for example a laser scanner, such that it covers at least the stopping distance in front of the vehicle in the longitudinal direction or strikes the plane there and transversely scans at least the requisite width of the carriageway.

The laser scanner on a vehicle could also safeguard the roadway 4 m ahead from a height of 2 m, for example. Thus, depending on the braking action and carriageway condition, even speeds of more than 15 km/h are optionally admissible.

If a detection, aimed far ahead, of the carriageway plane with methods which directly measure the distance, for example with a laser scanner, is not always possible due to jolting of the vehicle, for example if the vehicle travels quickly on a rough or uneven carriageway, markings on the carriageway can possibly be detected by a camera or a stereo camera. The markings, for example carriageway delimitation lines, can then also be used to detect and assess the carriageway plane.

It is a matter of definition whether there are objects or obstacles on the plane or whether these are merely tolerable roughnesses, tolerable unevennesses or a tolerable number of measurement errors. Corresponding tolerance values should be provided in the evaluation. Thus, for example in the case of rain and snow outdoors, measurement errors often occur. So that the vehicle is not stopped unnecessarily, it makes sense to exclude or to tolerate individual erroneous measurements by a filter.

The measurement result is of a good quality when all the distance values are present in full and they lie within the permissible tolerance. The plane can then also be used as a carriageway, i.e. no dangerous objects are on the carriageway, neither are there any holes or black objects. Therefore, the carriageway is complete and the operation has been checked.

In an embodiment, the plane in front of the vehicle can be detected as an entity in one photograph using a camera. Using other sensors, it can also be detected gradually line-by-line or dot-by-dot.

Thus, it is advantageous to detect the plane line-by-line during travel using a laser scanner, for example. In this case, the laser scanner is arranged such that it scans transversely over the carriageway plane. Depending on the scan and the driving speed, the carriageway plane is thus detected line-by-line so that the plane can be identified gradually.

In an embodiment, the plane can be detected and evaluated on a line and also on the surface. In particular during line-by-line detection, the rotatory movement of the vehicle is also to be considered, if appropriate, in addition to the translatory movement of the vehicle. This is important for also checking the evenness of the carriageway plane in the direction of travel. In contrast to when a camera is used, during line-by-line detection the plane is recorded in a plurality of stages in the longitudinal direction. The vehicle moves between these stages. The movement of the vehicle can be considered during identification of the plane.

Further features of the surroundings can also be used to test the method. For example, kerbstones, walls and other immovable objects. Devices which do not move, for example stationary machines, can also be detected while idle or also during travel. If the result of the measurement is as expected, this is usually confirmation that the method is working. Checks in particular during travel produce new measured values. The changes in measurement must appear where they are expected. This ensures that the old test results are not frozen and the computer is not hung.

The features can be found in, on, above or in the vicinity of the carriageway. They can be installed artificially, i.e. in addition to the examination or driving of the vehicle, or they can also be of a more or less natural origin, for example immovable objects which are present anyway.

The features can be of very different types. Using laser scanners, for example objects are detected which are raised, i.e. they differ in height from the carriageway plane and are represented by another distance.

On the other hand, visual contrasts are detected effectively using cameras. Thus, coloured markings on the plane, for example marking lines can be used to identify the plane by triangulation methods. If appropriate, the combination of laser scanners or other runtime-measuring methods and camera methods is also advantageous.

Since lasers, PMD and camera methods are optical technologies, it is advantageous, for example in the event of unfavourable weather, such as snow, rain or also strong and dazzling sunlight, to accept ultrasound or radar methods.

To check the operation, it is appropriate to use changes in movement of the vehicle. For example, during accelerating and braking of a sprung-mounted vehicle, the distance of the sensor to the observation area on the plane changes. During starting and braking, the vehicle will pitch and the distance will be reduced. When the vehicle pitches, not only can the operation of the plane monitoring be tested, but possibly also the effect of the braking procedure. The pitching degree is an indication of the braking deceleration.

Furthermore, the method is tested in that the sensor is moved relative to the vehicle. In this respect, a rotatory or translatory movement or a combination thereof can take place. Particularly during a rotatory movement, the detection range can change significantly so that other measured values are then possibly also expected. When the movement of the sensor is known and when there is an expectation about the surroundings (target value), then a test can be carried out using the new measured values to ascertain whether the method is working. However, the curved area can also be detected, for example when the sensor is moved into a new direction of travel, for example during turning. Due to a translatory movement, the sensor obtains a new perspective and, as a result, it can identify objects in a more reliable manner and can possibly detect them more effectively in three dimensions. The translatory movement can be used similarly to the spacing (basis) of two cameras in stereo technology.

The distance to the plane, and also to objects, obstacles and the like can also be determined, for example using a camera by tracking contrasts in the detection range when the vehicle continues to move in a defined manner. For a moving vehicle, close contrasts and high contrasts move more than remote and low contrasts from photograph to photograph from the camera's viewpoint. The distance to the camera as well as the level of contrast to the plane can be determined from the original position of the contrast in the first photograph and, compared thereto, from the position in the second photograph.

Conversely, according to this method, the speed of the vehicle can also be determined if it is possible to assume that the contrasts are actually located in the plane.

In principle, it is possible to detect raised objects or other three-dimensional features using laser scanners or other runtime-measuring methods instead of contrasts and to track them in movement similarly to the manner in which contrasts can be tracked using cameras. The method enhances the detection quality. The contrasts can also be, for example carriageway markings, but also shadows on the plane.

Suitable for measuring the distance of the plane are also stereo cameras, but also methods by which, for example, dots, lines or optical patterns are projected onto the carriageway. The distance is then determined by receivers and evaluators which use the triangulation method. The size, for example the width of a known marking, can also be used to determine the distance of said marking (intercept theorem).

While stereo methods are also suitable outdoors in bright daylight and in the case of great distances, the optical projection (also split beam method) is more advantageous in the close-up range or also indoors. Here, the bright sunlight does not disturb the projected pattern.

In split beam methods or generally in projection methods, lines, dots or other patterns are projected onto the plane to be monitored in the optical or adjacent frequency range, for example by a line laser. The pattern on the plane is examined using a suitable receiver, for example a camera which is arranged at a known distance to the laser, i.e. it views the plane from another direction. When there are disturbances on the plane, for example objects, the pattern is seen in a different direction, depending on the size of the object.

When the vehicle pitches or during a change, permissible per se, in the gradient of the carriageway, erroneous obstacles or disturbances are possibly indicated by a linear intercept sensor which projects the pattern, for example a line, merely transversely to the direction of the carriageway onto the plane. Therefore, it is advantageous to use the linear intercept sensor in combination with other sensors, also with other linear intercept sensors which observe another part of the plane. However, the plane can also be inspected within a greater region with the projection of two-dimensional patterns, for example two-dimensionally distributed dots, parallel lines, grids or the like. Objects, obstacles and the like can then be distinguished from the pitching of the vehicle or from the changing gradient of the carriageway. It is then possible to detect these objects etc. discretly, so to speak, and to distinguish them from the otherwise acceptable plane.

With the two-dimensional inspection of the plane, it is also possible to detect small differences in height in the thoroughfare, for example door sills or different coverings. Compared to conventional runtime-measuring methods, linear intercept sensors and other image-generating methods generally have a better resolution. With the appropriate information evaluation (3D, also image evaluation), it is then even possible to distinguish on the plane the hand of a small child (obstacle) from transitional floorings, for example from parquet to carpet (no obstacle). Differences in brightness and colour on the plane or between the plane and objects etc. are also helpful and they advantageously support the evaluation, if the distance alone is inadequate for evaluating the plane (3D), and vice versa.

In the linear intercept method, the pattern is relatively small compared to the surface under observation. The emitted energy is concentrated efficiently onto the pattern, as a result of which the pattern is perceived all the clearer in contrast. It is then helpful to compare a photograph with a pattern against a photograph without a pattern. In the differential image, the pattern emerges more clearly, irrespective of the local illumination.

However, it is also appropriate to work with flash light, for example to detect edges on the plane. Depending on the arrangement relative to the flash device, the surfaces are illuminated differently and can thus be detected by the sensor (camera). In this respect, it is also advantageous here to compare the differences using a photograph with flash against a photograph without flash.

The use of infrared patterns or flashes does not disturb people; in turn, the use of visible patterns or flash light can also be used as an indication of an approaching vehicle. In this respect, the use of the combination of different methods compensates for weaknesses in individual methods.

Contrasts can also be presented in the invisible spectrum in brightness, i.e. more or less black-white or in the colour thereof. Apart from the detection of contrasts, brightness and colour can be used for inspecting the plane. If the brightness or colour is incorrect, a defect, a marking, a danger or a different plane region can be present. Irrespective of daylight, brightness and optionally also colour can be evaluated better with artificial lighting, also with flash light.

It is also advantageous that carriageway markings which are used for lane guidance can be differentiated by the distance test of raised contrasts, for example objects and obstacles. This test also increases the significance of the marking detection.

Furthermore, it is advantageous when at least two sensors are used which are directed onto the plane with different degrees of steepness. It can happen, for example, that on a wet carriageway, the sun or another radiation source reflects in the plane, thereby making it difficult or impossible for a sensor to detect the plane. It is then advantageous for the sensors to be directed at different angles onto the carriageway. They possibly also have different locations. The measuring quality can thus be improved at least for one of the sensors.

According to another configuration, a plurality of sensors is used for different areas. A far-reaching sensor can initiate slow driving as a warning sensor, for example. Another sensor with a short range is possibly responsible for stopping or for an emergency stop. What are known as contacting or tactile sensors, for example bumpers or safety edges, have proved successful for a very short range.

Plane monitoring is suitable both for fully automatic vehicles and for assistance systems. Depending on the environmental conditions, it may happen that for example rain, snow, an unfavourable position of the sun etc. are erroneously detected obstacles by the plane monitoring system. If, for example, an automatic vehicle stops although no obstacle is present, this can be detected wirelessly by camera image transmission and by displaying the vehicle surroundings on a monitor. By teleoperation, an authorised person can then enable the continued travel of the vehicle.

The method, in particular the sensor system, can also be tested in that where there are light-emitting or other energy-emitting sensors, this energy source is deactivated for self-testing. The measurement to the plane and for determining the plane then has to justifiably indicate an error or another reaction thereto.

If a danger is detected, a stop or slow driving procedure will usually take place. However, it is important that the initiation of the slow driving procedure is also tested. The deceleration can also be established by measuring the speed, for example via incremental transmitters.

However, it is advantageous to directly measure the change in acceleration by an acceleration sensor. To ensure the deceleration, the acceleration sensor has to provide a corresponding minimum value. Thus it is then possible, for example, that upon detection of an obstacle at a great distance in front of the vehicle, a moderate braking deceleration is firstly initiated until the vehicle reaches a slower, more acceptable speed or until the vehicle stops. If the acceleration sensor does not establish an adequate braking action, the vehicle can still be stopped reliably by an emergency stop, if necessary.

Speed sensors, also path sensors, for example incremental encoders, can also be used for testing the acceleration sensor, or vice versa.

Furthermore, changes in the plane, for example other inclines or steps, i.e. jumps, or other changes can also be established. These changes can be tolerable or even expected if the course is known and stored. Changes can be used for obstacle detection or navigation, for example.

The plane can be identified not only in that the distance measurements are within the tolerance range for the expected distances. It can also be identified by comparing adjacent measured values. With a rough carriageway, the individual measured values naturally fluctuate to a greater extent compared to a smooth carriageway. However, if the values fluctuate more than is expected, this can also be due to the measuring accuracy and can thus be an indication of the measuring quality. Where there are large fluctuations between the individual adjacent measured values, confidence in the measurement may possibly decline. Other measuring methods may then be necessary or corrections may have to be made. However, confidence increases if the quality of the measured values is good.

If a rough carriageway or a rough area is established, but a smooth area is expected, a discrepancy can also be established here. If even a smooth area compared to a rough area can be established, these areas can also be distinguished. This can be used both for obstacle detection and for navigation. In turn, combined with changes in distance or also changes in the surface colour and surface brightness, this can be used for contrast formation or object, obstacle or defect detection.

Ambiguous measurement results are also repeatedly produced in the case of runtime-measuring or direction-finding methods (laser, radar, ultrasound), depending on reflection. In the case of lasers, it is frequently floating particles (rain, snow, dust, fog) which do not produce a clear measurement result. In the case of radar and ultrasound, it is also reflections on objects in the vicinity which result in ambiguities.

In this respect, it is advantageous to check whether, with the expected plane, the reference values (target values) are present in the measured values (actual values) and whether they can be identified. Here as well, tolerances with respect to the measured values will possibly have to be accepted. The other differing, implausible values can then be disregarded, if appropriate. This approach greatly facilitates, for example the recovery of landmarks and other known reflectors or contrasts. Thus, for example with a snowfall it is possible to filter out the disturbances caused by snowflakes from the many measurement results using a laser scanner and to detect the carriageway plane, when now and again measured results are found which are consistent with the expected distance to the carriageway plane (plausibility). If no measured result corresponds to the expected distance measurements, an obstacle may possibly be present. The quality of the plane is detected as being adequate or is detected as being sufficiently reliable or safe when there are enough successful conformities within the tolerance between the measured values (actual values) and the reference values (target values).

If a plurality of differences, typically with the same tendency, arises between the reference values of the expected plane (also expected image) and the measured values, also current image, it then makes sense to provide an improved conformity by rotatory or translatory displacement or by a similar adaptation. The vehicle has possibly moved in a different manner than intended. The best conformity can be used for error determination and identification, correction, but also as a new reference for the next plane detection.

Depending on use, it is advantageous to continue the method via a plurality of measurements, so that individual measurement errors in individual photographs or in individual scans, for example, can be compensated. Thus, it is then possible for actual objects or obstacles to be determined more effectively when they are confirmed by continuous measurement detection procedures. In the case of optical and runtime-measuring methods, the use of filters is suitable to eliminate individual measurement errors. However, if a plurality of adjacent measured values shows the same discrepancy, a deviation from the plane can be accepted as having been reliably detected. Depending on the configuration, it is thus possible to filter out not only individual measurement errors, but also disturbances caused by floating particles, for example snow and rain. It then has to be established how many adjacent measured values are required to accept a deviation from the plane.

With some methods, i.e. the stereo method, determining the distance to the plane and to objects is complicated, to some extent ambiguous and thus often faulty. The principle of the stereo method is that at least two photographs are taken from different locations. To determine the distance, the same contrasts have to be found in the photographs and have to be compared with each other. The same contrasts have different positions in the photographs. The smaller the distance, the greater the difference (disparity). The difference is used to determine the distance. However, finding the identical contrasts in the photographs and allocating them correctly is a complex procedure.

According to a further configuration, it is extremely advantageous if reference values (distance values) are already present for the plane to be detected. Depending on the position on the reference plane (target plane), the disparities dependent on the distance can be derived and are known. The comparison of the stereo photographs becomes much easier because a check merely needs to be made as to whether the photographs are identical, if appropriate, within an acceptable tolerance, bearing in mind the distance-dependent disparity. If the comparison of the photographs shows clear differences, then objects, obstacles or other discrepancies or also known features or landmarks have been detected. The method saves a great amount of calculating time and presents fewer errors than previous methods.

Furthermore, it is possible to proceed similarly to the stereo methods when photographs are produced from different locations. For example, photographs using cameras from a vehicle towards the carriageway plane can advantageously be used. Contrasts and similar features are detected with a first photograph. This photograph acts as a reference. When the vehicle travels a bit further and a further photograph is taken, the contrasts which are on the plane must also appear in the second photograph where they are expected due to the movement of the vehicle, i.e. they must have moved correspondingly closer to the vehicle.

Like the stereo method for comparing two photographs depending on the distance of the area to be examined on the carriageway plane, a greater disparity can be used for close range and, decreasing continuously, smaller disparities can be used for far range, for photographs which are taken successively during travel, a greater displacement can be taken as a basis for close range and accordingly smaller displacements or disparities in the photographs can be taken as a basis for far range. These disparities are predetermined from the geometric conditions for contrasts on the plane.

However, if the contrast has a greater or smaller displacement or disparity than would be expected for a feature on the plane, then this feature must be located above or below the plane. This must therefore be a feature which belongs to an object.

The advantage of the method is that even from the first photograph it is possible to determine where the contrasts are to be sought in the second photograph. Therefore, an expected image (reference) can already be produced for the second photograph.

In the next step, it is then relatively simple to compare the second photograph with the expected image, if appropriate to also form a difference. If the expected image and the second photograph are identical, i.e. if there is no difference, then an undisturbed, i.e. expected plane is present. There is then usually no object or obstacle on the carriageway. Complicated calculations, which can otherwise be necessary with image-generating systems, are not required.

If there are discrepancies between the expected image (reference) and the second photograph, the position of the travelling vehicle may also have changed unexpectedly. This can relate to an unexpected rotatory and a translatory change. If the discrepancies are established in relatively large areas of the photograph or if they tend to continue in further photographs, the discrepancies can be used to correct the position, the position determination or also to discover errors of the path and direction measuring means (odometry) or of other sensors.

Runtime-measuring methods, for example laser scanners, measure the distance in a direct and reliable manner. However, they require a relatively great amount of time per measurement and usually operate in two dimensions. Camera methods, for example stereo cameras, record in each photograph the entire plane or a large part of the relevant plane and in principle can provide a large amount of data. However, they require contrasts and the evaluation is often less reliable.

The use of both methods is advantageous. The laser can reliably determine the position of the plane. On this basis, contrasts can be shown in more detail and measured by a stereo camera, for example. If the position of the plane is already known, many ambiguities are disregarded for the evaluation of the stereo images. The evaluation becomes faster, simpler and more reliable. In particular when further photographs are taken as the vehicle moves and said photographs are compared, the evaluation provides a great reliability and a high quality. Where there are even greater requirements, it is advantageous anyway to observe the plane from different positions using a plurality of sensors. As a result, three-dimensional objects can also be virtually backlit or the surrounding scene can be presented more effectively. This also helps to enhance the measuring quality or to avoid blinding caused by radiation sources, for example the sun, or other disturbances.

A plane detection can be carried out as reference for the further plane detection and evaluation. This procedure can also be performed directly on site in what is known as a teach-in method. In this method, the position of the plane, roughness, unevenness, brightness, colour and the like can be recorded. The relevant tolerance values can also be input automatically or manually, as required. Further detected planes will then be measured and compared against this reference plane.

Depending on the location, one or various reference planes can be used for guiding a vehicle, i.e. for guiding it in the lane and also for controlling its speed. If discrepancies are established, a stopping procedure, a different speed or, if it is possible to assess the situation on the plane accordingly, an evasion strategy, for example driving around obstacles, can be initiated. Contrasts or other features, for example landmarks can be sought and used to thereby guide the vehicle. In general, it must be possible to be able to expect the landmarks. They are components of a road map. They can be, for example, markings in or on the plane, but also raised features. They can also be distinctive features or changes in the position of the plane, changes in roughness, unevenness, brightness, colour and the like.

The method is suitable for measuring experience, monitoring, assistance and for automatic operation.

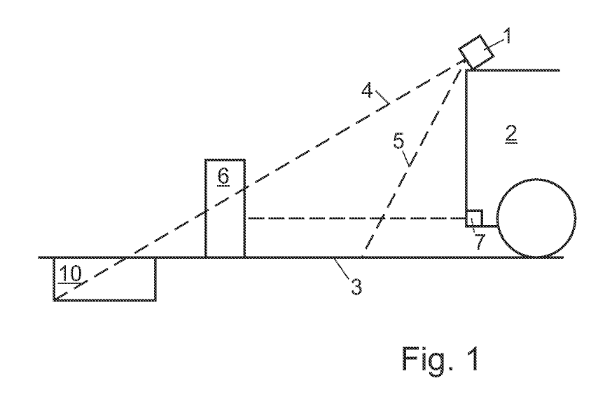

In FIG. 1, the carriageway plane (3) is observed by a sensor (1), for example a laser scanner, which is positioned on a vehicle (2). The sensor (1) can position a scanning beam (4) transversely over the carriageway plane (3). It is expedient for at least the carriageway width or the width of the vehicle (2) to be detected and for the sensor (1) to be directed at a sufficient distance ahead so that, upon detection of an object (6), in this case an obstacle, the vehicle can be stopped in good time.

If an object (6) is detected which is raised above the carriageway plane (3), the distance from the sensor (1) to the object (6) is shorter than the distance to the carriageway plane (3) would be. The carriageway can be detected particularly effectively in close range and thus the method is suited better to close range than far range.

Horizontal laser scanners (7) are usually attached such that they detect the surroundings in a virtually disc-shaped manner parallel to the plane, but also in a small spacing from the plane. In this respect, it is found that they can effectively detect light objects (6). However, it is also clear that they do not detect objects (6) if they are black and that furthermore they do not detect any depressions or holes (10) in the carriageway. This is a fundamental safety problem of known horizontal laser scanners (7). A further disadvantage is that they do not detect obstacles located higher up, for example an overhanging load, drawbars of trailers and the like.

It is also typical that perhaps on the right and left of the thoroughfare they detect the legs of a table or the wheels of a vehicle, but not the top of the table or the body of the vehicle. It is then of course advantageous for the sensor (1) to be in a significantly higher position and also for it to protect the upper region of the vehicle (2). However, it can also be advantageous to combine horizontal laser scanners (7) with the sensor (1) which is directed downwards from above.

If the sensor (1) is a laser scanner, it is also possible to detect the carriageway plane (3) when the vehicle (2) is stationary. For this, the sensor (1) must be tiltable or rotatable about its transverse axis, i.e. the laser scanner must be able to detect the area between scanning beam (4) and lower scanning beam (5). This can take place automatically, for example. Alternatively however, the carriageway plane (3) can also be detected virtually in an image in this area by PMD cameras, stereo cameras or by other technologies. Thus, objects and obstacles can also be detected which are located under the scanning beam (4).

If the sensor (1) is a laser scanner which is only arranged according to scanning beam (4), the carriageway plane (3) can also be detected when the vehicle (2) is moving. During travel, the carriageway plane (3) is then gradually recorded in stages by the individual scans.

Multi-beam laser scanners are also suitable which can record a plurality of lines virtually simultaneously.

During the scanning procedure of the horizontally oriented laser scanner (7), a plane is scanned in a circular manner, for example 10 cm above the ground. In so doing, the laser scanner beam also strikes the object (6). However, if the object is completely black, no reflection is returned and the object is not detected.

Advantageously with the invention, the sensor (1) which is directed obliquely forwards is a laser scanner, for example, which observes the entire carriageway or carriageway plane (3). The scanning beam (4) usually strikes the carriageway plane (3) at an expected distance.

In the illustrated example, the scanner is attached to a lorry, for example 3 m above the carriageway and is aligned so that its beam should strike the carriageway approximately 4 m in front of the lorry. According to trigonometry, the beam strikes the carriageway plane (3) at a distance of 5 m. If an object (6) is located there, it is seen directly. The distance is then not 5 m, but only 3 m, which is recognised as a defect or obstacle. The vehicle is decelerated. However, if the object is black, it is not seen directly. Since, however, there is no feedback, this is recognised as a deviation from the plane and the vehicle is likewise decelerated.

This is the first advantage of the patent application, that the carriageway plane (3) is expected at a known distance, for example 5 m. If there is no reflection at this distance, a danger or uncertainty is present in any case. Black objects are therefore also detected. This is an essential advantage over the known methods which only use a horizontal laser scanner (7) which does not react reliably to black objects.

In driving situations in which the vehicle rolls or the carriageway ascends or descends, the measured values differ from a target value. For example, it can be that the measured distance is shown as only 4.8 m or 5.2 m instead of 5 m, although no obstacle or object is present. It is therefore advantageous for the “evenness” to also be determined, i.e. the course of the measured values transversely to the direction of travel.

Here, the invention takes advantage of the fact that although the laser scanner is subjected to considerable absolute error influences due to disturbing influences, such as temperature and light, with directly successive measurements, only small relative errors arise. Since with temporally successive measurements only small relative errors arise, relatively small objects can then also be clearly detected, particularly if they are presented in a virtually sharp-edged manner, i.e. if they present a point of discontinuity.

To provide a clearer understanding, this connection will be explained using an example. If the absolute accuracy of the scanning method is 5 cm, an object with a height of 1 cm can still also be detected, because the repeat accuracy is less than 1 cm or a jump can also be detected in that, for example, 10 measurements in front of the object statistically form a different average than 10 measurements on the object. After the object, the 10 measurements should again statistically correspond to the values before the measurements.

In principle, indentations or bumps can also be detected, i.e. objects which have a relatively flat ascent. In this respect, the statistical significance increases with the width of the object.

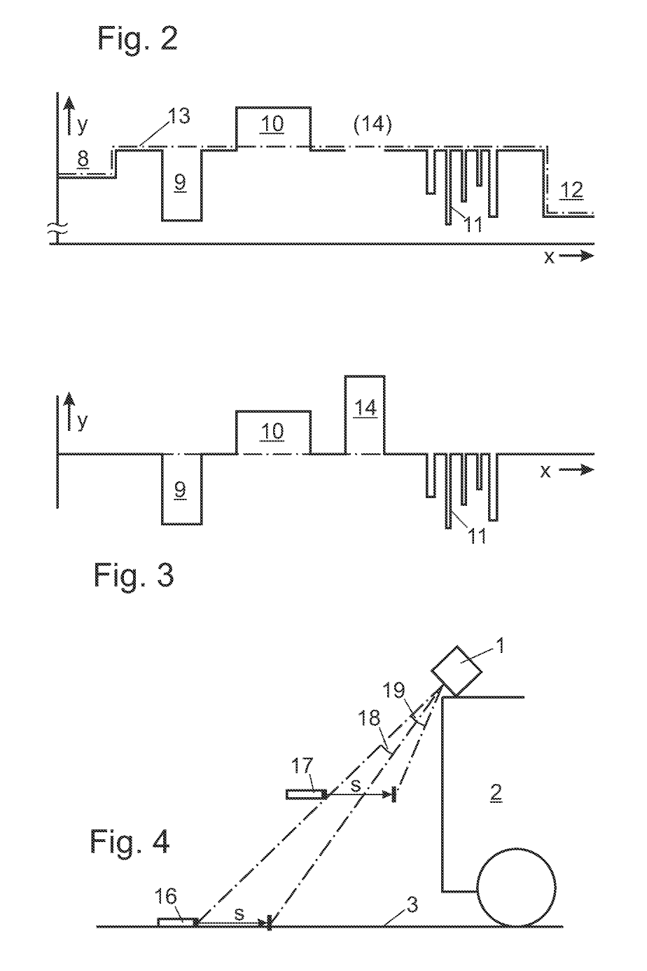

In FIG. 2, the distance (y) over the carriageway width (x) is shown, for example when a laser scanner scans the carriageway plane (3) transversely. From the left there is a kerbstone (8), an obstacle (9), a hole (10), a black object (14), floating particles (11) and an immovable object (12). In the case of the hole (10), the distance is further than in the case of the carriageway plane (3). Typically, no signal is detected for a black object (14).

The floating particles (11) can be rain, snow, leaves or the like. Usually, the reflected image is again different in the next scan, so that the floating particles (11) can conventionally be distinguished from individual stationary installations, i.e. permanent installations. The reflected image of fog also differs from floating particles (11) and can be evaluated, if required. The reflected image of fog is also relatively diffuse and thus differs from floating particles. The distinction of these different reflections is important, inter alia, in the evaluation of the danger situation in front of a vehicle (2). In the case of floating particles (11) or fog, the vehicle does not normally have to brake, whereas the vehicle does have to brake in the event of genuine obstacles (9).

The immovable object (12) is a permanent installation. It can be used for the lane guidance of a vehicle (2), for example along a crash barrier or wall, or also for determining location in the direction of travel, for example on ceilings, doors, pillars and the like. Even holes (10) in the carriageway plane can be used as a local reference.

The reference line (13) represents the distance values which are expected in this location on the carriageway plane (3). If the reference values and the measured values are in agreement, the carriageway is as expected. When there are discrepancies, an object (6) can be detected or an obstacle (9) or a disturbance can be recognised.

FIG. 2 is shown in an idealised manner. Reference line (13) or correspondingly the carriageway plane (3) are in fact at a greater distance than in the middle on the right and left from the viewpoint of the sensor (1). This distortion has been corrected here to provide a clearer view, so that reference line (13) in the carriageway region appears as a straight line.

FIG. 3 relates to FIG. 2 and shows over the width of the carriageway the difference between the measured values and the reference values. If the measured values correspond to the expected reference values, no discrepancy can be found. However, the discrepancies caused by the obstacle (9), the hole (10), the black object (14) and the floating particles (11) can be seen.

FIG. 4 shows a sensor (1), for example a camera, on a vehicle (2) moving over the carriageway plane (3). The figure shows that contrasts at different heights can be detected by tracking the contrasts. The marking contrast (16) on the carriageway plane (3) is detected by the sensor (1) in the same direction as the object contrast (17).

After a specific time when the moving vehicle (2) has travelled somewhat further, from the viewpoint of the camera (1), the contrasts have apparently moved by the distance (S) further towards the vehicle. However, the marking contrast (16) now appears to be displaced by a relatively small angle (18) and the object contrast (17) appears to be displaced by a relatively large angle (19). The height of the object marking (17) over the carriageway plane (3) and the distance to the sensor (1) or to the vehicle (2) can be calculated if the height of the sensor (1) over the carriageway plane (3), the distance (S) and the relatively large angle (19) are known.

When a first photograph is taken of the carriageway plane (3) from a first location, then according to the known distance (S) it can be pre-calculated where the carriageway marking contrasts (16) are to be expected in the next photograph. An expected image (reference) for the next photograph is formed from the first photograph.

If contrasts in the expected image correspond to the next photograph, they are located on the carriageway plane (3) and if they do not correspond, they possibly belong to an object. The formation of the expected image is a simple process. It is then no longer necessary to use complex calculation methods if the true location of the contrasts is not needed.

In the decision whether or not it is possible to travel over the carriageway plane (3), it suffices to establish whether or not the contrasts belong to the carriageway. If the disparity between the photographs is too great, it is immaterial how high or low the contrasts are above or below the carriageway. The method is significantly simpler than methods which calculate the actual location of the contrast.

An expected image formed from the second photograph can be used as a reference for the third photograph etc. Contingent upon the course of the carriageway, there can naturally be differences of the second expected image from the first expected image. Translatory and rotatory movements may be possible.

The use of stereo cameras is also advantageous in this application. If the stereo camera consists of a camera on the right and a camera on the left, the distance of contrasts in particular which run longitudinally in the direction of travel can be reliably determined. On the other hand, with photographs which are taken one after another in time, contrasts in particular which run transversely are determined more effectively in distance when the vehicle has travelled slightly further. In this respect, the combination of stereo camera and evaluation of different photographs is advantageous for continued driving.

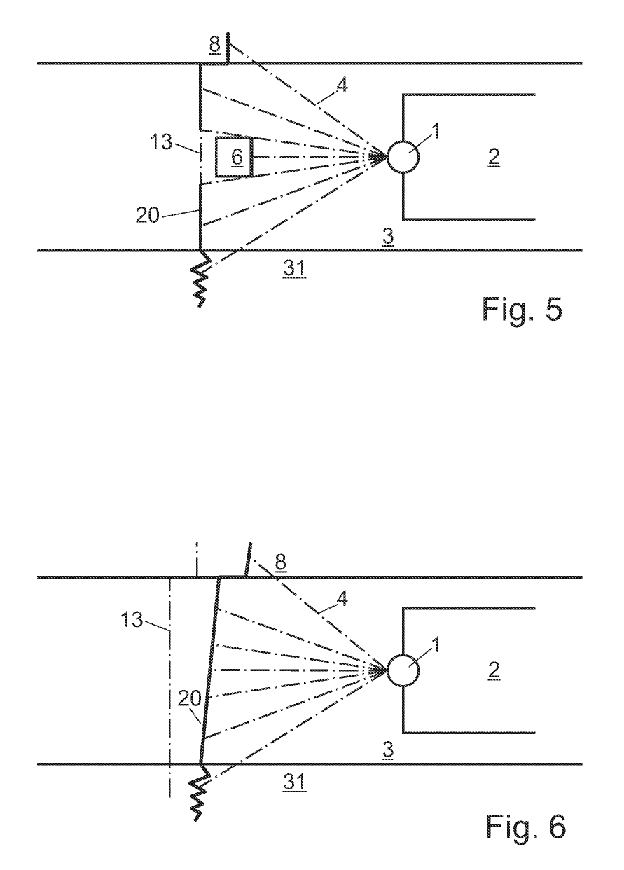

The method is described in more detail in FIG. 5 in conjunction with FIGS. 1 to 4. FIG. 5 is a plan view of the vehicle (2) on the carriageway plane (3) in front of an object (6). A laser line (20) is scanned by the sensor (1) (for example a laser scanner) via the individual scanning beams (4). Without an object (6), the laser line (20) would run in the expected reference line (13). The scanning line is slightly shorter over the known kerbstone (8) than on the carriageway plane (3). The expected jump on the kerbstone (8) can also be used for navigation purposes, i.e. for guiding the vehicle (2).

A hard shoulder (31) can be seen on the other side of the carriageway plane (3). For example, in the case of a grass-covered area, the texture can be different from that on the carriageway plane (3). Therefore, the hard shoulder (31) is also detected and can also be used for lane guidance or it could also be assessed as an obstacle.

The object (6) is clearly detected as being an obstacle. The scanning beams (4) are significantly shorter in this area than expected. If a reference line (13) of, for example 3 m were to be expected in place of the object (6), and if a tolerance of perhaps ±0.4 m were allowed in the distance, but the object (6) is detected at a shorter distance of 2.5 m, then object (6) is also an obstacle. On the other hand, the roughnesses on the hard shoulder (31) can be so small that they are still within the tolerance of 0.4 m and are possibly not recognised as an obstacle. The analysis of the texture can be used as a distinguishing feature, i.e. for detecting objects and planes etc.

The sensor (1) is located at a particular height and is directed obliquely onto the carriageway plane (3). It can be seen that the outer scanning beams (4) on the carriageway plane (3) are longer than the inner scanning beams (4) when they meet on the reference line (13). Bearing in mind the height of the sensor (1) above the carriageway plane (3) and the inclination of the sensor (1), it can be recalculated that the reference line (13) should be more or less a straight line, depending on the evenness of the carriageway plane (3). The scanned laser line (20) (actual values) must in principle remain within the tolerance. The tolerance is exceeded at the object (6). Here, a filtering can also take place. If only a single measurement exceeds the tolerance, then this may be, for example, the detection of a snowflake, a raindrop or a particle of dust. It is then more advantageous to see whether a plurality of adjacent distance measurements exhibits the same discrepancy or whether these discrepancies are measured again in the subsequent scan. The object (6) must then reveal itself to a certain extent by a particular width and also by a temporal permanence.

The sensor (1) can be, for example, a laser scanner, a stereo camera, another runtime-measuring means, but also a pattern projector with a camera (also split beam method). The patterns can be dots, lines, grids etc. A transversely running projection line could correspond to the laser line (20). For small distances, split beam methods are very suitable indoors. For example, they can effectively also detect differences in the thoroughfare plane (3), for example distinguishing a carpeted floor from a parquet floor.

It is clear that the use of different methods helps in evaluating the carriageway plane. Thus, differences in brightness (black and white camera) or also carriageway differences between carriageway plane (3), kerbstone (8), hard shoulder (31) and object (6) can greatly assist and confirm the distance-based measurements, in particular when the differences in the distance are too unsafe or too small.

FIG. 6 shows an operating situation which differs from that of FIG. 5. The vehicle (2) is to scan the reference line (13) using the sensor (1). However, the laser line (20) in fact runs in a relatively short distance and runs obliquely. The reason for this can be that the vehicle (2) has pitched and rolled relative to the carriageway plane, possibly due to a braking procedure or to unilateral loading. It may also be that the carriageway plane (3) ascends slightly or has an incline on one side. The permissible tolerance with respect to the reference line (13) would possibly now be exceeded. However, the situation will not be assessed as a dangerous situation, because the laser line (20) on the carriageway plane (3) still forms a straight line. No interruption or discontinuity point can be seen in this straight line.

A bar lying transversely over the carriageway plane (3) would also fulfill the straight line condition, although the bar is an obstacle. For this reason, it would be more advantageous to establish using a plurality of scanning lines, perhaps also with the projection of a grid, that most of the carriageway plane (3) is present, but there is a transverse interruption. Transverse obstacles can also be detected by a transversely scanning sensor (1) if a plurality of measurements are taken during travel and, in this respect, an inadmissible increase and decrease in the distance is established, also considering the pitching of the vehicle (2), if appropriate.

While FIG. 5 shows how obstacles are detected by absolute distance measurements, FIG. 6 shows that the evenness is also detected, even if the tolerances in the distance are exceeded. Only if the straight line equation is exceeded inadmissibly would an object or obstacle be detected in the laser line (20).

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

What is claimed is:

1. A method for detecting and evaluating a plane for recognition of an object comprising:
detecting the object using a sensor disposed on a vehicle, the object being present in a direction of a relative direction of movement of the vehicle and the sensor being directed onto the plane;
determining a distance of the sensor from at least one measuring point using a control unit;
comparing a value of the determined distance with a reference value so as to obtain a difference value; and
delivering the difference value to an evaluation unit as at least one of an object, an obstacle, a hole, a floating particle, a defect in the plane and a measurement error.

2. The method as recited in claim 1, wherein the object is detected using a further sensor.

3. The method as recited in claim 1, wherein the value of the determined distance is compared with the reference value and used in at least one of examination and calibration.

4. The method as recited in claim 1, wherein additional values transverse to the direction of movement are detected using the sensor.

5. The method as recited in claim 4, wherein a surface of the plane is identified and deviations from the plane based on the additional values are detected.

6. The method as recited in claim 1, wherein the detected measured values of the distance are compared with previous detected measured values of the distance, and wherein points of discontinuity are determined based on the comparison.

7. The method as recited in claim 1, wherein at least one of a deceleration and acceleration-induced inclination of the vehicle is detected and is compared with a speed measurement signal by the control unit.

8. The method as recited in claim 1, wherein the sensor is arranged such that it is one of adjustable and movable in at least two working conditions relative to the vehicle.

9. The method as recited in claim 1, wherein the value of the distance is determined based on a tracking of at least one of a contrast and a characteristic feature while taking into account the movement of the vehicle.

10. The method as recited in claim 9, wherein a distance between the contrast and the sensor is determined.

11. The method as recited in claim 9, wherein the contrast and the characteristic feature are produced using optical projection onto the plane.

12. The method as recited in claim 1, wherein at least one of a color and a brightness of the plane is examined.

13. The method as recited in claim 1, wherein the distance is determined at different angles of the measuring direction with respect to the plane.

14. The method as recited in claim 1, wherein the distance is measured by a plurality of sensors having angled measurement directions.

15. The method as recited in claim 1, wherein at least one further sensor is configured to detect additional objects in different safety areas.

16. The method as recited in claim 15, wherein the at least one further sensor is used to detect a plane for at least one of transverse driving and cornering.

17. The method as recited in claim 1, wherein a surface quality of a surface is detected and compared with a record in a database so as to obtain a difference between the surface and the object.

18. The method as recited in claim 1, the vehicle is one of decelerated and stopped based on the difference value.

19. The method as recited in claim 1, wherein a speed of the vehicle is decelerated in a controlled manner when an obstacle is established.

20. The method as recited in claim 1, wherein an acceleration sensor is used to check a deceleration of the vehicle.

21. The method as recited in claim 1, wherein a deceleration is restricted to a predetermined operational limiting value, and wherein the deceleration is adjusted to a maximum deceleration which goes beyond the operational limiting value based on a minimum distance from the object that is not ensured by the deceleration limited to the predetermined operational limiting value.

22. The method as recited in claim 1, wherein measured values are subject to an evaluation and individual measured values are excluded from a further signal processing.

23. The method as recited in claim 1, wherein stereo technology is used and known disparities are considered for comparison of photographs.

24. The method as recited in claim 1, wherein the detected measured values are used as reference values in a first position and are used as comparative values for detected measured values in a second position.

25. The method as recited in claim 1, wherein at least one of run-time measuring and image-detecting sensors are used for detection of measured values.

26. The method as recited in claim 1, wherein a plane is detected so as to form a reference.

27. The method as recited in claim 1, wherein a plane is detected by at least two intersecting measuring lines.

28. The method as recited in claim 1, wherein detected measured values are compared with absolute measured values and measured values of adjacent measurement points.
